(19) United States
(12) Patent Application Publication
(10) Pub. No.: US 2019/0335653 A1
(43) Pub. Date: Nov. 7, 2019

(54) Rake and Shovel Apparatus

(71) Applicants: Julio Ochoa, Phoenix, AZ (US); Francisco Rodriguez, Phoenix, AZ (US)

(72) Inventors: Julio Ochoa, Phoenix, AZ (US); Francisco Rodriguez, Phoenix, AZ (US)

(21) Appl. No.: 16/401,158

(22) Filed: May 2, 2019

Related U.S. Application Data
(60) Provisional application No. 62/665,749, filed on May 2, 2018.

(51) Int. Cl. A01D 11/06; A01B 1/02; A01B 1/20

(52) U.S. Cl. CPC A01D 11/06; A01D 7/02; A01B 1/20; A01B 1/02

(57) ABSTRACT

A rake and shovel apparatus. The apparatus includes a rake comprising a first shaft and a rake head, and a shovel comprising a second shaft and a shovel head. A first fastener is disposed on the first shaft, and a corresponding second fastener is disposed on the second shaft. A connector is configured to removably secure to an upper end of each of the first shaft and the second shaft, such that the apparatus can be stored in a hanging configuration if desired. In use, the first fastener is configured to removably secure to the second fastener so as to removably secure the rake to the shovel, defining a volume between the rake head and the shovel head that can be used to receive and transport solid materials.

### CROSS REFERENCE TO RELATED APPLICATIONS

This application claims the benefit of U.S. Provisional Application No. 62/665,749 filed on May 2, 2018. The above identified patent application is herein incorporated by reference in its entirety to provide continuity of disclosure.

### BACKGROUND OF THE INVENTION

The present invention relates to shovel and rake combination devices. More specifically, the present invention provides a rake and shovel apparatus that can be secured in a configuration to define a volume between the rake and shovel for receiving and transporting solid materials.

Tools such as rakes and shovels are commonly used by individuals when completing various outdoor tasks, such as when completing yardwork, for example. Yardwork and other similar tasks typically require large amounts of manual labor using various tools such as rakes, shovels, and the like. It can be difficult for individuals with limited mobility or other physical problems to constantly switch between and utilize different gardening tools. One method to gather leaves and other solid debris is to utilize both a rake and a shovel held against each other to support material between the rake head and the shovel head. While this method helps to gather and transport extra material, it can be difficult for an individual to maintain the two tools in such a way that they support the extra material and debris therebetween. In view of the above concerns, it is desirable to provide a rake and shovel apparatus that can be secured in such a way has to hold and transport solid material between the rake and shovel.

Devices have been disclosed in the known art that relate to shovel and rake combination devices. These include devices that have been patented and disclosed in patent application publications. However, these devices have several drawbacks. For example, the devices in the known art typically relate to shovels and rakes that are pivotally connected. The pivotal movement makes it difficult to maintain the shovel and rake horizontally against one another to retain material therebetween. Other devices fail to provide shovel and rake combinations that include both end connectors and a shaft connector, for storage and in-use configurations, respectively.

In light of the devices disclosed in the known art it is submitted that the present invention substantially diverges in design elements from the known art, and consequently it is clear that there is a need in the art for an improvement to existing shovel and rake combination devices. In this regard the present invention substantially fulfills these needs.

### SUMMARY OF THE INVENTION

In view of the foregoing disadvantages inherent in the known types of shovel and rake combination devices now present in the prior art, the present invention provides a rake and shovel apparatus wherein the same can be utilized for providing convenience for the user when collecting and transporting solid materials. The rake and shovel apparatus includes a rake comprising a first shaft and a rake head, and a shovel comprising a second shaft and a shovel head. A first fastener is disposed on the first shaft, and a corresponding second fastener is disposed on the second shaft. A connector is configured to removably secure an upper end of each of the first shaft and the second shaft, such that the apparatus can be stored in a hanging configuration or any other desired configuration when not in use. In use, the first fastener is configured to removably secure to the second fastener so as to removably secure the rake to the shovel, defining a volume between the rake head and the shovel head that can be used to receive and transport solid materials.

One object of the present invention is to provide a rake and shovel assembly that includes all of the advantages of devices in the known art and none of the disadvantages.

Another object of the present invention is to provide a rake and shovel assembly that allows users to easily gather and transport solid materials.

A further object of the present invention is to provide the convenience of both a rake and a shovel in a single apparatus.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the rake and shovel apparatus.

FIG. 2A shows a perspective view of the shovel component of an embodiment of the rake and shovel apparatus.

FIG. 2B shows a side elevation view of the shovel component of an embodiment of the rake and shovel apparatus.

FIG. 3A shows a perspective view of the rake component of an embodiment of the rake and shovel apparatus.

FIG. 3B shows a side elevation view of the rake component of an embodiment of the rake and shovel apparatus.

FIG. 4 shows a first embodiment the fastener components of an embodiment of the rake and shovel apparatus.

FIG. 5 shows a second embodiment the fastener components of an embodiment of the rake and shovel apparatus.

FIG. 6 shows a third embodiment the fastener components of an embodiment of the rake and shovel apparatus.

FIG. 7 shows a fourth embodiment the fastener components of an embodiment of the rake and shovel apparatus.

### DETAILED DESCRIPTION OF THE INVENTION

Reference is made herein to the attached drawings. Like reference numerals are used throughout the drawings to depict like or similar elements of the rake and shovel apparatus. For the purposes of presenting a brief and clear description of the present invention, the preferred embodiment will be discussed as used for gathering, handling, and transporting solid materials. The figures are intended for representative purposes only and should not be considered to be limiting in any respect.

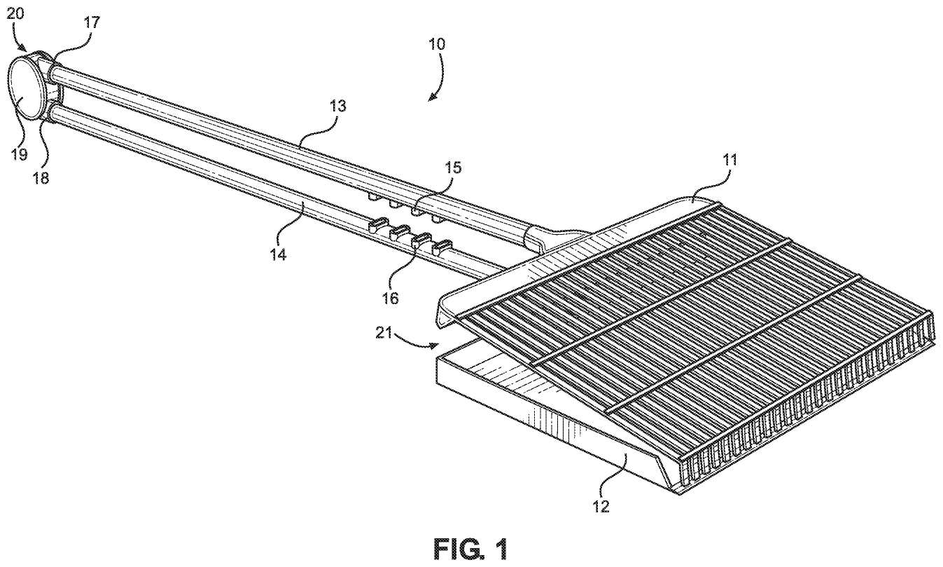

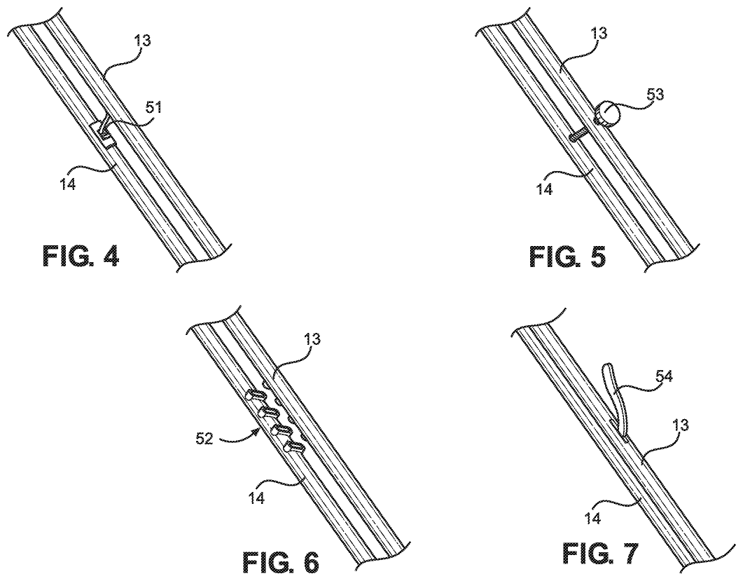

Referring now to FIG. 1, there is shown a perspective view of an embodiment of the rake and shovel apparatus. The apparatus 10 generally includes a rake 11 and a shovel 12 that are removably securable to each other such that an interior volume 21 is defined therebetween. The rake 11 includes a first elongated shaft 13, and the shovel 12 includes a similar second elongated shaft 14. The first elongated shaft 13 of the rake 11 includes a first fastener 15 thereon, and the second elongated shaft 14 of the shovel 12 includes a second fastener 16 thereon. The first fastener 15 is configured to removably secure to the second fastener 16. In the illustrated embodiment, the first fastener and second faster 15, 16 comprise a tongue and groove system configured to friction secure the rake 11 to the shovel 12. However, any other suitable fasteners 15, 16 may be utilized, and FIGS. 4-7 show examples of different fasteners 15, 16.

The apparatus 10 includes a connector 20 that provides an additional mechanism for removably securing the rake 11 to the shovel 12. In the shown embodiment, the connector 20 includes a main body 19 having a pair of receivers 17, 18 thereon. Each receiver 17, 18 is configured to receive an upper end of one of the shafts 13, 14 in frictional engagement therewith. The connector 20 is configured to support the rake 11 and shovel 12 in such a way that it can be easily stored in a desired configuration, such as hanging from a hook in a garage, for example. In other embodiments, the connector 20 may include additional mechanisms for securing the rake 11 to the shovel 12 in a non-use configuration.

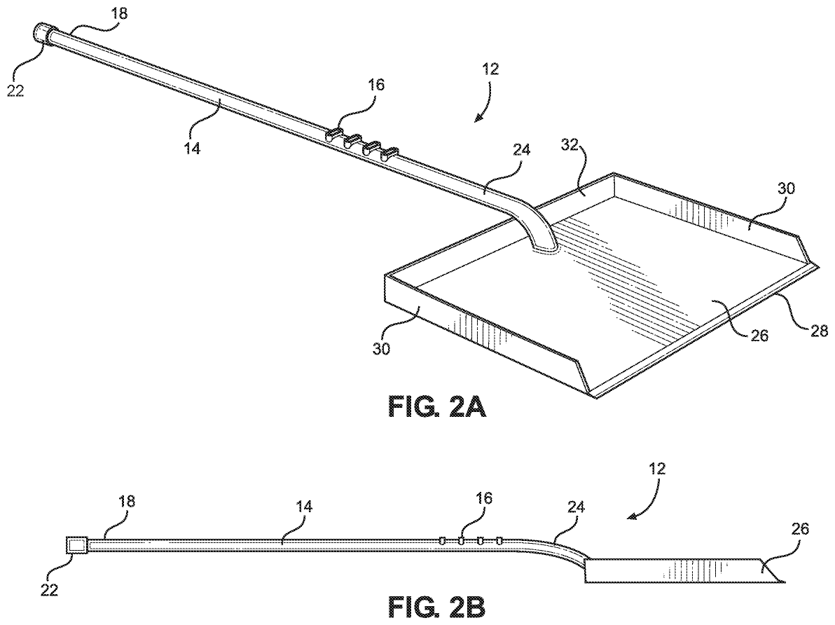

Referring now to FIGS. 2A and 2B, there is shown a perspective view of the shovel component of an embodiment of the rake and shovel apparatus and a side elevation view of the shovel component of an embodiment of the rake and shovel apparatus, respectively. In the illustrated embodiment, the shovel 12 includes an elongated shaft 14 that has fasteners 16 thereon for securement to the rake. The elongated shaft 14 further includes a downwardly curved forward end 24 attached to a shovel head 26. The curved forward end 24 allows the shovel 12 to be secured to the rake in such a way that they are spaced apart to form an interior volume or space for holding solid material. The shovel head 26 includes a pair of sidewalls and a rear wall 32 extending upwardly from perimeter edges of the shovel head 26. In the shown embodiment, the shovel head 26 includes a sharpened forward edge 28 that helps to scrape solid material onto the shovel head 26 for collection and transport. Further, in the shown embodiment, the elongated shaft 14 includes a rubber or other resiliently formed end cap 22 disposed on a rear end thereof.

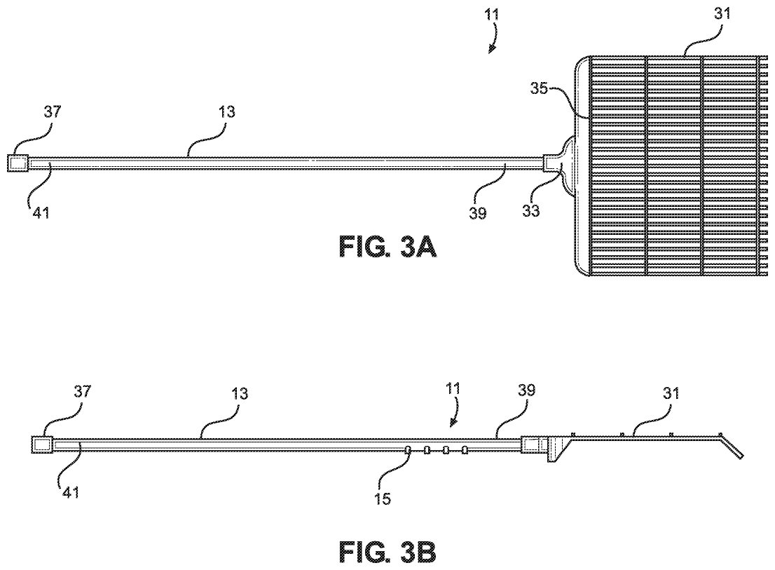

Referring now to FIGS. 3A and 3B, there is shown a perspective view of the rake component of an embodiment of the rake and shovel apparatus and a side elevation view of the rake component of an embodiment of the rake and shovel apparatus, respectively. The rake 11 includes an elongated shaft 13 having corresponding fasteners 15 for removably securement to the shovel. In the shown embodiment, a similar end cap 37 is disposed on an upper end 41 of the elongated shaft 13 of the rake 11. A rake head 35 comprising a plurality of parallel tines 31 is affixed to a lower end 39 of the elongated shaft 13 of the rake 11. In the shown embodiment, a tapered connector 33 is affixed to the rake head 35 and includes an aperture configured to frictionally secure the elongated shaft 13 therein. Further, in the shown embodiment, the tines 1 include angled distal ends that assist with the operation 11 of the rake. Further, the angle distal ends of the tines 31 are configured to contact the forward edge of the shovel head when the rake 11 is secured thereto, as can be seen in FIG. 1.

Referring now to FIGS. 4-7, there are shown various embodiments of the first and second fastener components of an embodiment of the rake and shovel apparatus. In one embodiment, shown in FIG. 4, the rake shaft 13 and shovel shaft 14 includes a hook and ring fastener assembly 51. In this embodiment, the first fastener comprises a hook and the second fastener comprises a ring configured to removably receive the hook, allowing the rake shaft 13 to be removably secured to the shovel shaft 14. In another embodiment, as shown in FIG. 5, the apparatus includes a threaded thumb screw assembly 53. In this embodiment, the first fastener comprises a first threaded aperture and the second fastener comprises a second threaded aperture, wherein a threaded screw is receivable and removably securable through each of the first and second threaded apertures, which are disposed on the rake shaft 13 and shovel shaft, respectively.

In another embodiment, as shown in FIGS. 1 and 6, the fastening mechanism includes a first fastener which comprises a plurality of tongues and a second which fastener comprises a plurality of grooves configured to removably receive the plurality of tongues in frictional engagement therewith. In another embodiment, as shown in FIG. 7, the locking mechanism includes a locking lever mechanism. In this embodiment, the first fastener comprises a locking lever 54 and the second fastener comprises a slot (not visible) that is configured to removably receive the locking lever 54, such that the locking lever 54 is configured to prevent separation of the rake shaft 13 from the shovel shaft 14 when the locking lever 54 is secured within the slot.

In another embodiment (not shown), the rake shaft 13 and the shovel shaft 14 include a magnetic fastening mechanism, which includes at least one magnet disposed on either shaft and at least one attractant member disposed on the opposing shaft that is configured to attract the magnet to removably secure the shafts of the rake and the shovel 13, 14 to each other. In alternate embodiments, one or more magnets may be incorporated into other fastening mechanisms to improve their effectiveness. For example, magnets may be utilized within the tongue and groove fasteners shown in FIGS. 1 and 6 in order to provide a more stable connection between the rake and the shovel.

In operation, the shovel and rake may be utilized indecently of one another as desired. When a user wishes to carry a load of debris using each tool combined, the user may load the shovel head with material secure the rake shaft to the shovel shaft defining an interior volume that holds the material therein. The user may then lift the shovel and rake apparatus upwardly, with the shovel head supporting the material and the rake head covering the material and preventing it from being blown away or otherwise falling off of the shovel head during transport. Additionally, the upper ends of the shafts of the rake and shovel can be secured to each other for storage purposes. In this way, the present invention can be utilized to efficiently retain and transport solid materials using a single apparatus that combines the benefits of both a shovel and a rake, wherein the apparatus can be secured in an alternative configuration for storage.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) A rake and shovel apparatus, comprising:
a rake comprising a first shaft and a rake head;
a shovel comprising a second shaft and a shovel head;
a first fastener disposed on the first shaft;
a second fastener disposed on the second shaft;
a connector configured to removably secure an upper end of each of the first shaft and the second shaft;
wherein the first fastener is configured to removably secure to the second fastener so as to removably secure the rake to the shovel.

2) The rake and shovel apparatus of claim 1, wherein the second shaft includes a downwardly curving portion that connects to the shovel head.

3) The rake and shovel apparatus of claim 1, wherein the shovel head includes an end wall and a pair of sidewalls extending upwardly therefrom.

4) The rake and shovel apparatus of claim 1, wherein the shovel head comprises a sharpened forward edge.

5) The rake and shovel apparatus of claim 1, wherein the first fastener comprises a plurality of tongues and the second fastener comprises a plurality of grooves configured to removably receive the plurality of tongues in frictional engagement therewith.

6) The rake and shovel apparatus of claim 1, wherein the first fastener comprises a hook and the second fastener comprises a ring configured to removably receive the hook.

7) The rake and shovel apparatus of claim 1, wherein the first fastener comprises a locking lever and the second fastener comprises a slot configured to removably receive the locking lever, such that the locking lever is configured to prevent separation of the first shaft from the second shaft when the locking lever is secured within the slot.

8) The rake and shovel apparatus of claim 1, wherein the first fastener comprises a first threaded aperture and the second fastener comprises a second threaded aperture, wherein a threaded screw is receivable and removably securable through each of the first and second threaded apertures.

9) The rake and shovel apparatus of claim 1, wherein the rake head includes a plurality of tines having angled distal ends that contact a forward edge of the shovel head when the first shaft is removably secured to the second shaft.

10) The rake and shovel apparatus of claim 1, wherein an interior volume is defined between the rake head and the shovel head when the first shaft is removably secured to the second shaft.

11) A rake and shovel apparatus, comprising:
a rake comprising a first shaft and a rake head;
a shovel comprising a second shaft and a shovel head;
a first fastener disposed on the first shaft;
a second fastener disposed on the second shaft;
a connector comprising a main body and a pair of receivers disposed thereon, wherein a first receiver of the pair of receivers is configured to removably receive and secure to an upper end of the first shaft, and wherein a second receiver of the pair of receivers is configured to removably secure to an upper end of the second shaft;
wherein the first fastener is configured to removably secure to the second fastener so as to removably secure the rake to the shovel.

12) The rake and shovel apparatus of claim 11, wherein the second shaft includes a downwardly curving portion that connects to the shovel head.

13) The rake and shovel apparatus of claim 11, wherein the shovel head includes an end wall and a pair of sidewalls extending upwardly therefrom.

14) The rake and shovel apparatus of claim 11, wherein the shovel head comprises a sharpened forward edge.

15) The rake and shovel apparatus of claim 11, wherein the first fastener comprises a plurality of tongues and the second fastener comprises a plurality of grooves configured to removably receive the plurality of tongues in frictional engagement therewith.

16) The rake and shovel apparatus of claim 11, wherein the first fastener comprises a hook and the second fastener comprises a ring configured to removably receive the hook.

17) The rake and shovel apparatus of claim 11, wherein the first fastener comprises a locking lever and the second fastener comprises a slot configured to removably receive the locking lever, such that the locking lever is configured to prevent separation of the first shaft from the second shaft when the locking lever is secured within the slot.

18) The rake and shovel apparatus of claim 11, wherein the first fastener comprises a first threaded aperture and the second fastener comprises a second threaded aperture, wherein a threaded screw is receivable and removably securable through each of the first and second threaded apertures.

19) The rake and shovel apparatus of claim 11, wherein the rake head includes a plurality of tines having angled distal ends that contact a forward edge of the shovel head when the first shaft is removably secured to the second shaft.

20) The rake and shovel apparatus of claim 11, wherein an interior volume is defined between the rake head and the shovel head when the first shaft is removably secured to the second shaft.
